(19) United States
(12) Patent Application Publication
(10) Pub. No.: US 2010/0169074 A1
(43) Pub. Date: Jul. 1, 2010

(54) METHOD OF CONFIGURING USER PREFERENCES ON ELECTRONIC DEVICE

(75) Inventors: LIANG-MAO HUNG, Tu-Cheng (TW); CHUN-WEN WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/467,077

(22) Filed: May 15, 2009

(30) Foreign Application Priority Data
Dec. 31, 2008 (CN) 200810306760.X

(51) Int. Cl. G06F 17/20

(52) U.S. Cl. 704/8

(57) ABSTRACT

A method of configuring user preferences on an electronic device is disclosed. The method includes detecting a geographic location of the electronic device through a network. A local language setting is obtained according to the geographic location, and the local language setting is established as a default language setting of the electronic device.

### BACKGROUND

1. Technical Field

The disclosure relates to electronic device use and, particularly, to a method of configuring user preferences on an electronic device.

2. Description of Related Art

An electronic device, such as a digital media player that can display images and play videos, often stores data on a hard drive, microdrive, or flash memory.

In common use, such an electronic device requires configuration of language, time zone, and Network Time Protocol (NTP) server to correspond to the user's geographical location and preferences. The language is often selected from a list, as is a time zone. The NTP server address is specified or input. It is complicated and time-consuming for configurations to be completed from the lists.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic device accepting input of user preferences according to the disclosure.

FIG. 2 is a flowchart of a method of configuring user preferences on an electronic device according to the disclosure.

### DETAILED DESCRIPTION

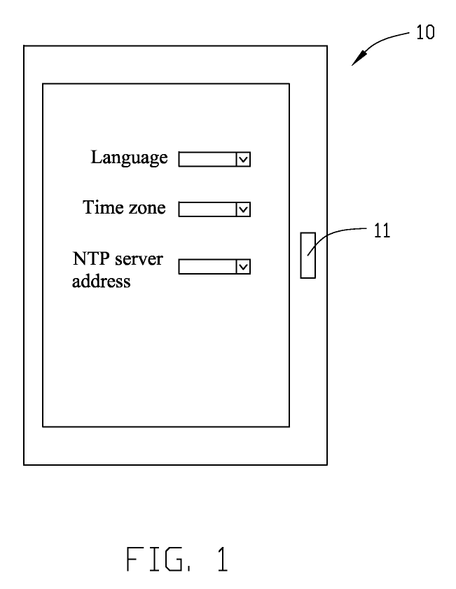

Referring to FIG. 1, an electronic device 10, here, a digital media player as an example, includes a port 11 capable of network connection, such as to a wired local area network interface or wireless local area network interface. A user interface accepting input of values of a language setting, time zone, and Network Time Protocol (NTP) server address is shown.

NTP is a protocol for synchronizing the clocks of computer systems over packet-switched, variable-latency data networks. The NTP uses UDP (User Datagram Protocol) on port 123 as its transport layer. It is designed particularly to resist the effects of variable latency by using a buffer.

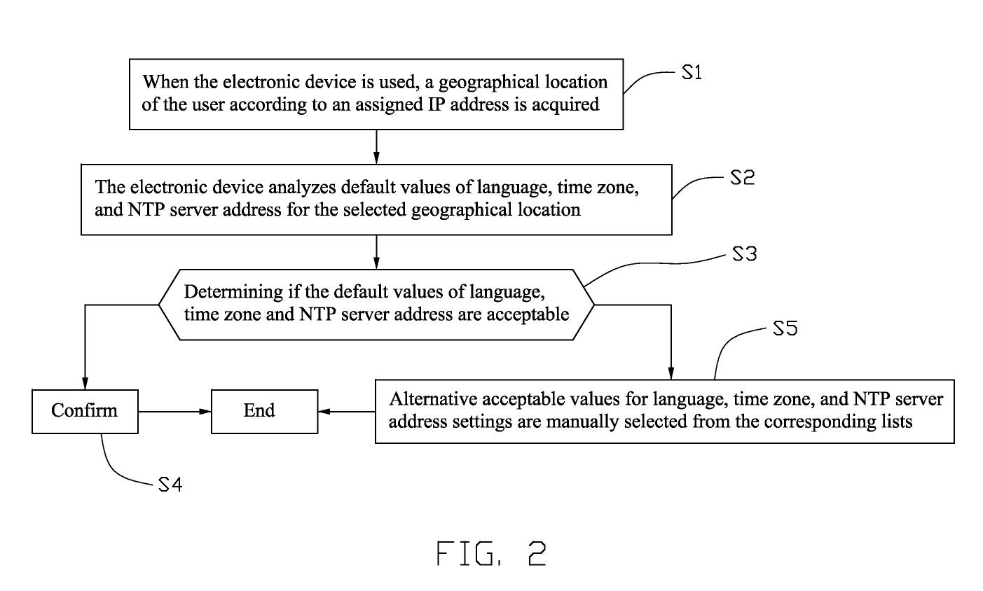

Referring to FIG. 2, the method of configuring user preferences on an electronic device includes the following steps:

In Step 1, when the electronic device 10 is used, a geographical location of the user according to an assigned IP address is acquired, by, for example, a global positioning system may be installed in the electronic device 10.
In Step 2, the electronic device 10 analyzes default values of language, time zone, and NTP server address for the selected geographical location. The electronic device 10 displays the default settings.
In Step 3, if the default values of language, time zone and NTP server address are acceptable, Step 4 is implemented. If not, Step 5 is implemented.
In Step 4, the displayed default values of language, time zone and NTP server address are confirmed.
In Step 5, alternative acceptable values for language, time zone, and NTP server address settings are manually selected from the corresponding lists.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of configuring user preferences on an electronic device comprising:
detecting a geographic location of the electronic device through a network;
obtaining a local language setting according to the geographic location; and
establishing the local language setting as a default language setting of the electronic device.

2. The method of configuring user preferences on an electronic device of claim 1, further comprising obtaining a time zone setting corresponding to the geographic location.

3. The method of configuring user preferences on an electronic device of claim 1, further comprising acquiring a NTP server address corresponding to the geographic location.

4. The method of configuring user preferences on an electronic device of claim 1, wherein the electronic device comprises a port providing network access.

5. The method of configuring user preferences on an electronic device of claim 4, wherein the port is a wired local area network port.

6. The method of configuring user preferences on an electronic device of claim 4, wherein the port is a wireless local area network port.

7. The method of configuring user preferences on an electronic device of claim 1, wherein the electronic device acquires a geographic location through the IP address.

8. The method of configuring user preferences on an electronic device of claim 1, wherein the electronic device acquires a geographic location through a global positioning system.

9. The method of configuring user preferences on an electronic device of claim 1, wherein the electronic device is a digital media player.
